(19) United States
(12) Patent Application Publication
(10) Pub. No.: US 2015/0182886 A1
(43) Pub. Date: Jul. 2, 2015

(54) Filter Element Having Dual Filtration Capacity and Filter Assembly

(71) Applicant: Caterpillar Inc., PEORIA, IL (US)

(72) Inventors: Bryant A. MORRIS, Peoria, IL (US); Jeffrey R. RIES, Metamora, IL (US)

(73) Assignee: Caterpillar Inc., PEORIA, IL (US)

(21) Appl. No.: 14/146,393

(22) Filed: Jan. 2, 2014

(51) Int. Cl. B01D 29/58

(52) U.S. Cl. CPC B01D 29/58

(57) ABSTRACT

A filter element may include a tubular member including a partition at least partially defining first and second chambers. The partition may be configured to prevent flow communication between the first and second chambers within the tubular member. The tubular member may further include an inlet port configured to provide flow communication into the first chamber, and an outlet port configured to provide flow communication from the second chamber. The tubular member may also include at least one outlet aperture configured to provide flow communication out of the first chamber, and at least one inlet aperture configured to provide flow communication into the second chamber. The filter element may also include a filter medium associated with the at least one outlet and inlet apertures. The filter element may be configured such that fluid passing through the filter element passes through both the first chamber and the second chamber.

### TECHNICAL FIELD

The present disclosure relates to a filter element having dual filtration capacity and a filter assembly including the filter element, and more particularly, to a filter element configured to subject fluid to two filtration processes and a filter assembly including the filter element.

### BACKGROUND

Filter systems may be used to filter fluids associated with operation of a machine such as an internal combustion engine. For example, filter systems may be used to remove particles from fuel and lubricant. Under some circumstances, it may be desirable to subject a fluid to more than one filtration process, for example, to remove particles from the fluid having different characteristics, such as size. As a result, some filter systems include more than one filter assembly, with each filter assembly being configured to remove different types of particles from the fluid.

However, as machines become more complex, efficient component packaging becomes desirable. Thus, although in some machines it may be desirable to subject a fluid to more than one filtration process, providing more than a single filter assembly for providing desired filtration may be difficult due to space constraints. As a result, it may be desirable to provide a filter element and filter assembly that are configured to subject a fluid to more than a single filtration process, while efficiently using available space.

An attempt to provide desired filtration is described in U.S. Pat. No. 5,766,468 (“the '468 patent”) issued to Brown et al. on Jun. 16, 1998. Specifically, the '468 patent discloses a dual media fuel filter, which combines the functions of filtering the fuel passing from a fuel source to a lift pump, and filtering the fuel passing from the lift pump to the fuel injectors. The filter includes distinct primary and secondary fuel filter cartridges, which are compression loaded into a self-contained fuel filter canister adapted for threaded attachment to an engine block. The primary filter cartridge is provided to filter fuel drawn under suction from a fuel source into a lift pump, and is provided with a relatively coarse filtering medium to allow for adequate fuel to pass therethrough under negative pressure and cold temperature conditions. The secondary filter cartridge is provided with a relatively fine filtering medium to filter the fuel passing from the lift pump and into the fuel injectors.

Although the dual media filter of the '468 patent may provide for dual filtration, it requires two, separate filter cartridges and has an overly complex flow system. This may result in inefficient use of space and increased costs associated with providing two separate filter cartridges.

The filter element and filter assembly disclosed herein may be directed to mitigating or overcoming one or more of the possible drawbacks set forth above.

### SUMMARY

In one aspect, the present disclosure is directed to a filter element. The filter element may include a tubular member having a longitudinal axis and including a partition at least partially defining a first chamber and at least partially defining a second chamber. The partition may extend longitudinally in the tubular member and may be configured to prevent flow communication between the first chamber and the second chamber within the tubular member. The tubular member may also include an end portion at least partially defining an inlet port configured to provide flow communication into the first chamber, and at least partially defining an outlet port configured to provide flow communication from the second chamber. The tubular member may further include at least one outlet aperture configured to provide flow communication out of the first chamber, and at least one inlet aperture configured to provide flow communication into the second chamber. The filter element may also include a filter medium associated with the at least one outlet aperture and the at least one inlet aperture. The filter element may be configured such that fluid passing through the filter element from the inlet port to the outlet port passes through both the first chamber and the second chamber.

According to a further aspect, a filter element may include a tubular member having a longitudinal axis and including a partition at least partially defining a first chamber and at least partially defining a second chamber. The partition may extend longitudinally in the tubular member and may be configured to prevent flow communication between the first chamber and the second chamber within the tubular member. The tubular member may also include an end portion at least partially defining an inlet port configured to provide flow communication into the first chamber, and at least partially defining an outlet port configured to provide flow communication from the second chamber. The tubular member may further include at least one outlet aperture configured to provide flow communication out of the first chamber, and at least one inlet aperture configured to provide flow communication into the second chamber. The filter element may include a filter medium including a first portion associated with the at least one outlet aperture, such that fluid flowing from the first chamber through the at least one outlet aperture flows through the first portion of the filter medium. The filter medium may also include a second portion associated with the at least one inlet aperture, such that fluid flowing into the at least one inlet aperture flows through the second portion of the filter medium and into the second chamber. The filter element may be configured such that fluid passing through the filter element from the inlet port to the outlet port passes through both the first portion of the filter medium and the second portion of the filter medium.

According to still a further aspect, a filter assembly may include a filter base configured to be coupled to a machine, and a canister having an open end, a closed end, and being configured to be coupled to the filter base. The filter assembly may also include a filter element configured to be received in the canister. The filter element may include a tubular member having a longitudinal axis and including a partition at least partially defining a first chamber and at least partially defining a second chamber. The partition may extend longitudinally in the tubular member and may be configured to prevent flow communication between the first chamber and the second chamber within the tubular member. The tubular member may also include an end portion at least partially defining an inlet port configured to provide flow communication into the first chamber, and at least partially defining an outlet port configured to provide flow communication from the second chamber. The at least one outlet aperture may be configured to provide flow communication out of the first chamber, and the at least one inlet aperture may be configured to provide flow communication into the second chamber. The filter element may also include a filter medium associated with the at least one outlet aperture and the at least one inlet aperture. The filter element may be configured such that fluid passing through the filter element from the inlet port to the outlet port passes through both the first chamber and the second chamber.

### BRIEF DESCRIPTION OF THE DRAWINGS

FIG. 1 is a perspective section view of an exemplary embodiment of a filter assembly.

FIG. 2 is a partial perspective section view of the exemplary filter assembly shown in FIG. 1.

FIG. 3 is a perspective view of an exemplary embodiment of a portion of a filter element.

FIG. 4 is a perspective view taken from another angle of the exemplary portion shown in FIG. 3.

FIG. 5 is a partial end section view of an exemplary embodiment of a filter element.

FIG. 6 is a perspective view of an exemplary embodiment of a filter element.

### DETAILED DESCRIPTION

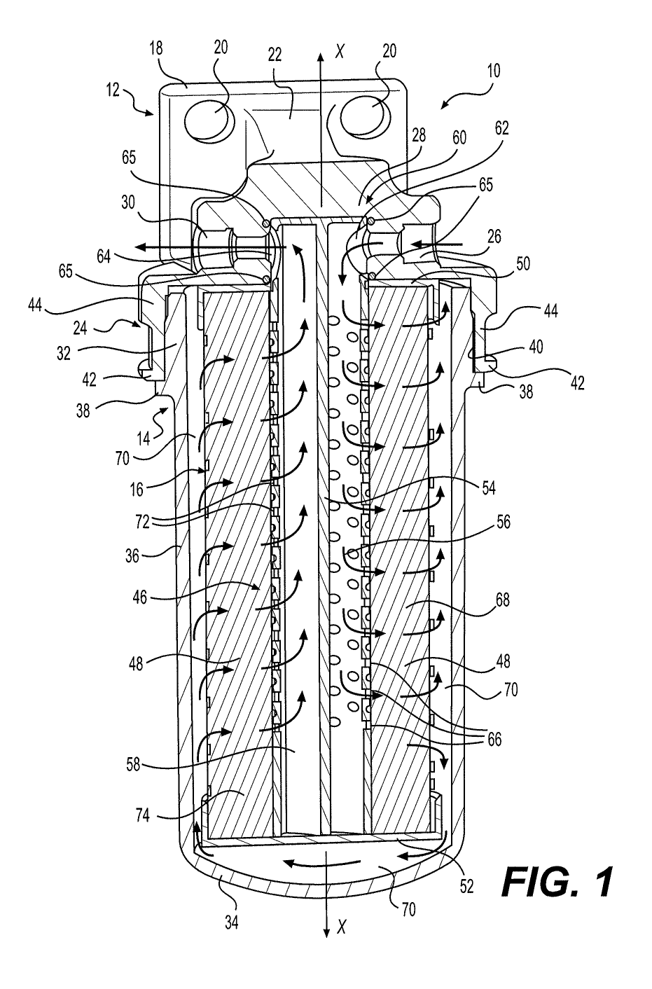

FIG. 1 illustrates an exemplary embodiment of a filter assembly 10. Filter assembly 10 may be used to filter fluids such as, for example, fuel, lubricants, coolants, and hydraulic fluid used by machines. According to some embodiments, filter assembly 10 may be used as a fuel/water separator filter and/or as an air filter. Other uses may be contemplated.

Exemplary filter assembly 10 shown in FIG. 1 includes a filter base 12 configured to couple filter assembly 10 to a machine, a canister 14 configured to be coupled to filter base 12, and a filter element 16 configured to be received in canister 14. Exemplary filter base 12 includes a mounting bracket 18 having at least one hole 20 (e.g., two holes 20) for receiving a fastener for coupling filter base 12 to a machine. Other coupling configurations are contemplated. Exemplary filter base 12 also includes an extension 22 and a canister coupler 24 configured to be coupled to canister 14. Extension 22 serves to space canister coupler 24 from mounting bracket 18 to provide clearance for canister 14.

As shown in FIG. 1, exemplary canister coupler 24 of filter base 12 includes an inlet passage 26, a receiver 28, and an outlet passage 30. Exemplary inlet passage 26 is configured to be coupled to a fluid conduit of a fluid system, such as, for example, a fuel system, a lubrication system, a hydraulic system, or a coolant system, such that it receives fluid for filtration in filter assembly 10. Exemplary receiver 28 is configured to receive a portion of filter element 16, as explained in more detail herein. Exemplary outlet passage 30 is configured to be coupled to a fluid conduit of the fluid system, such that fluid exiting filter assembly 10 returns to the fluid system following filtration.

Exemplary canister 14 shown in FIG. 1 includes an open end 32, an oppositely-disposed closed end 34, and a body portion 36 extending therebetween. Canister 14 includes a mounting flange 38 adjacent open end 32. In the exemplary embodiment shown, open end 32 of canister 14 is received in an open-ended housing 40 of filter base 12, with mounting flange 38 abutting an end 42 of a housing wall 44 of housing 40. One or more seals (not shown) of a type known to those skilled in the art may be provided between open end 32 of canister 14 and housing 40 to provide a fluid-tight barrier between canister 14 and housing 40 (e.g., between open end 32 and housing wall 44). Engagement structures (not shown) of a type known to those skilled in the art may be provided to secure canister 14 to filter base 12.

Exemplary canister 14 and housing 40 may define respective cross-sections. For example, canister 14 and housing 40 may define respective cross-sections that are substantially circular, substantially oval-shaped, and/or substantially polygonal. According to some embodiments, the cross-sections may be substantially constant along the longitudinal length of canister 14 (e.g., as shown in FIG. 1). According to some embodiments, the cross-sections may be vary along the longitudinal length of canister 14. The cross-sections may be chosen based on various considerations, such as, for example, the size and shape of the available space at a location of a machine that receives filter assembly 10.

As shown in FIG. 1, exemplary filter element 16 is received in canister 14 and cooperates with filter base 12 and canister 14, such that fluid received in inlet passage 26 of filter base 14 is filtered by filter element 16 and exits outlet passage 30 of filter base 14 following filtration. According to some embodiments, filter element 16 is configured such that fluid passing through filter element 16 from inlet passage 26 of filter base 12 to outlet passage 30 of filter base 12 is subjected to two filtration processes.

As shown in FIG. 1, exemplary filter element 14 includes a tubular member 46 substantially surrounded by a filter medium 48. Filter medium 48 may include any filter medium type known to those skilled in the art, such as, for example, foam-type, paper-type, and combinations thereof Some embodiments of filter element 14 include a first end cap 50 coupled at a longitudinal end of tubular member 46 at an end configured to be adjacent filter base 12 upon installation, and a second end cap 52 coupled at a longitudinal end of tubular member 46 opposite first end cap 50.

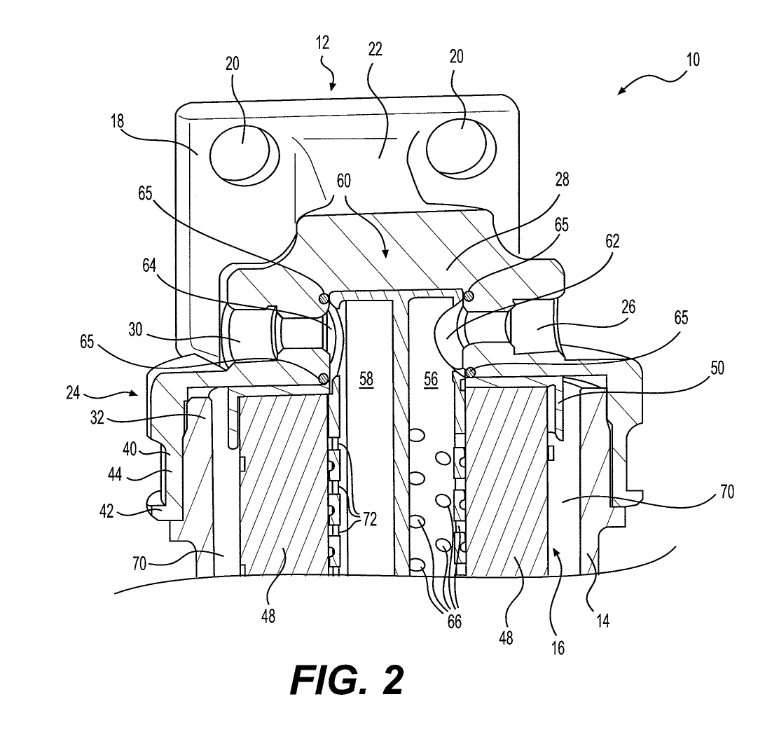

In the exemplary embodiment shown in FIGS. 2-5, tubular member 46 of filter element 16 defines a longitudinal axis X and includes a partition 54 at least partially defining a first chamber 56 and at least partially defining a second chamber 58. As shown, exemplary partition 54 extends longitudinally within tubular member 46 and prevents flow communication between first chamber 56 and second chamber 58 within tubular member 46. Tubular member 46 includes an end portion 60 at least partially defining an inlet port 62 and at least partially defining an outlet port 64. For example, for embodiments in which tubular member 46 has a substantially circular cross-section, inlet port 62 may be located circumferentially opposite outlet port 64.

As shown in FIGS. 1 and 2, exemplary end portion 60 is received in receiver 28 of filter base 12. One or more seals 65, such as, for example, O-ring seals shown in FIGS. 1, 2, and 6 may be provided to create a fluid-tight seal between end portion 60 of tubular member 46 and filter base 12. Exemplary inlet port 62 provides flow communication between inlet passage 26 of filter base 14 and first chamber 56 of tubular member 46. Exemplary outlet port 64 provides flow communication between second chamber 58 of tubular member 46 and outlet passage 30 of filter base 14. In the exemplary embodiment shown, inlet passage 26 and inlet port 62 provide the only fluid entry point for fluid entering filter element 16, and outlet port 64 and outlet passage 30 provide the only fluid exit point for fluid exiting filter element 16.

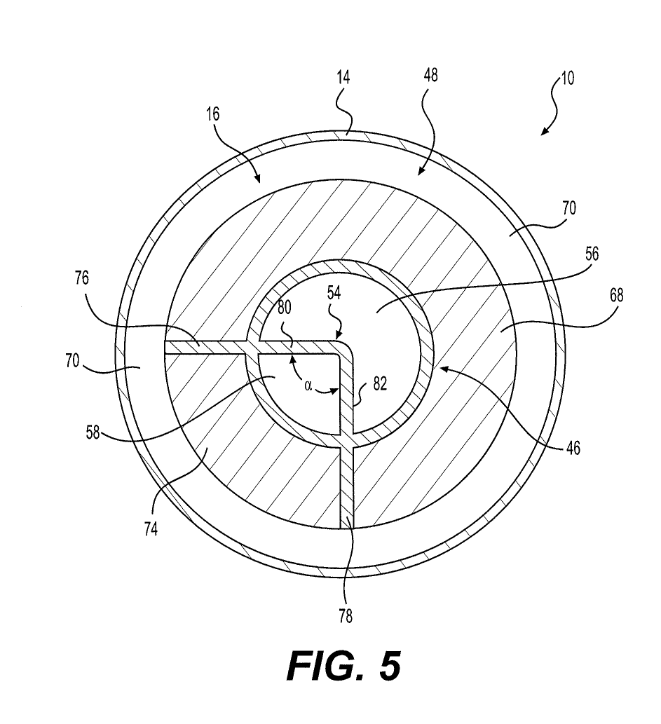

As shown in FIGS. 1-4, exemplary tubular member 46 includes at least one outlet aperture 66 (e.g., a plurality of outlet apertures 66 as shown) configured to provide flow communication out of first chamber 56, through a first portion 68 of filter medium 48, and into an interior space 70 of canister 14. Exemplary tubular member 46 also includes at least one inlet aperture 72 (e.g., a plurality of inlet apertures 72 as shown) configured to provide flow communication from interior space 70 of canister 14, through a second portion 74 of filter medium 48, and into second chamber 58 of tubular member 46. As shown in FIG. 5, first portion 68 of filter medium 48 is associated with outlet apertures 66, and second portion 74 of filter medium 48 is associated with inlet apertures 72. In particular, first portion 68 is located exterior and adjacent to outlet apertures 66, such that fluid flowing from first chamber 56 into interior space 70 of canister 40 passes through first portion 68, thereby filtering the fluid passing through outlet apertures 66. Second portion 74 is located exterior and adjacent to inlet apertures 72, such that fluid flowing from interior space 70 of canister 40 into second chamber 58 passes through second portion 74, thereby filtering the fluid passing through inlet apertures 72.

As shown in FIG. 1, exemplary filter assembly 10 is configured such that fluid passing through the filter element 16 enters filter assembly 10 via inlet passage 26 of filter base 12. Fluid flows from inlet passage 26 into inlet port 62 of end portion 60 and into first chamber 56. Thereafter, fluid flows out of at least one outlet aperture 66, through first portion 68 of filter medium 48, and into interior space 70 of canister 14. Passing through first portion 68 of filter medium 48 results in the fluid being subjected to a first filtration process. Once in interior space 70 of canister 40 following the first filtration process, the fluid is able to flow around filter element 16 within canister 40 and enter second chamber 58 of tubular member 46. For example, fluid may flow circumferentially around exemplary filter element 16 and/or between second end cap 52 and closed end 34 of canister 14 to second portion 74 of filter medium 48. Thereafter, the fluid passes through second portion 74 of filter medium 48, through at least one inlet aperture 72, and into second chamber 58. Passing through second portion 74 of filter medium 48 results in the fluid being subjected to a second filtration process. Thereafter, the fluid flows from second chamber 58 via tubular member 46 to outlet port 64, and exits filter element 16 via outlet passage 30 of filter base 12. Thus, in this exemplary embodiment, fluid passing through filter element 16 from inlet port 62 to outlet port 64 passes through both first chamber 56 and second chamber 58, for example, such that the fluid passing through filter element 16 from inlet port 62 to outlet port 64 passes through both first portion 68 of filter medium 48 and second portion 74 of filter medium 48. In this exemplary manner, fluid entering filter assembly 10 is subjected to two filtration processes within a single filter assembly including a single canister and a single filter element.

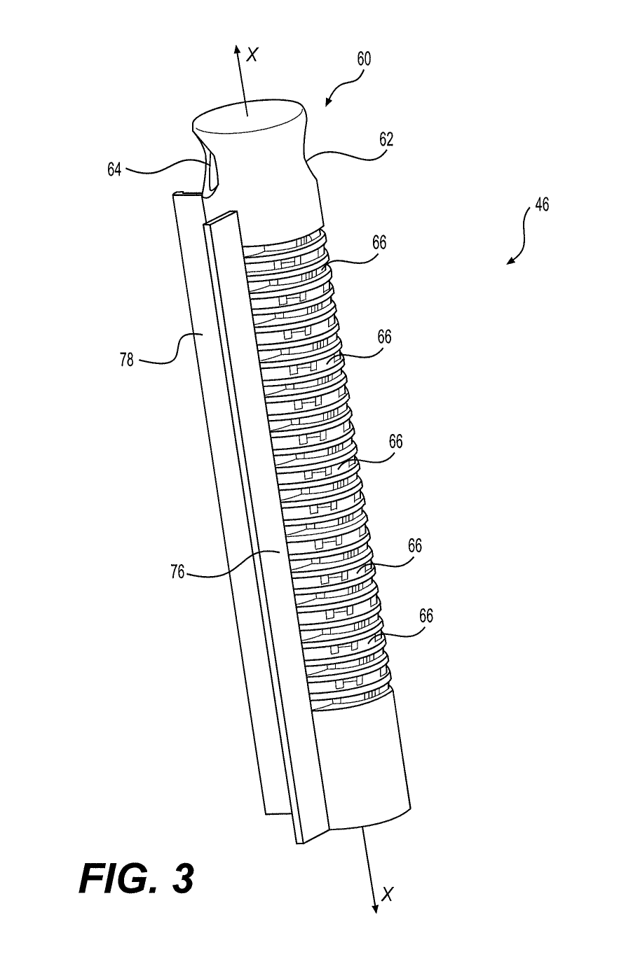

As shown in FIGS. 3-5, exemplary tubular member 46 includes at least a first barrier 76 and a second barrier 78 extending radially from the exterior surface of tubular member 46. As shown in FIG. 5, first portion 68 of filter medium 48 extends between first barrier 76 and second barrier 78 in association with first chamber 56. Second portion 74 of filter medium 48 extends between first barrier 76 and second barrier 78 in association with second chamber 58. First barrier 76 and second barrier 78 serve to prevent fluid exiting outlet apertures 66 from entering inlet apertures 72 without first passing through the entire thickness of first portion 68 and the entire thickness of second portion 74 of filter medium 48.

According to some embodiments, first barrier 76 and/or second barrier 78 may be substantially planar, for example, as shown in FIGS. 3-5. According to some embodiments, first barrier 76 and/or second barrier 78 may be curved. According to some embodiments, first barrier 76 and/or second barrier 78 may have a length such that respective ends of the barriers are substantially flush with an exterior surface of filter medium 48, for example, as shown in FIG. 5. According to some embodiments, first barrier 76 and/or second barrier 78 may have a length such that respective ends of the barriers extend beyond the exterior surface of filter medium 48. According to some embodiments, first barrier 76 and/or second barrier 78 may have a length such that respective ends of the barriers do not reach the exterior surface of filter medium 48.

In the exemplary embodiment shown, tubular member 46 has a substantially circular cross-section. According to some embodiments, tubular member 46 may have other cross-sections, such as, for example, substantially oval-shaped and substantially polygonal. According to some embodiments, the cross-sectional shape of tubular member 46 may be substantially constant along its longitudinal length, for example, as shown. According to some embodiments, the cross-section of tubular member 46 may be vary along its longitudinal length. The cross-section may be chosen based on various considerations, such as, for example, the size and shape of the available space at a location of a machine that receives filter assembly 10.

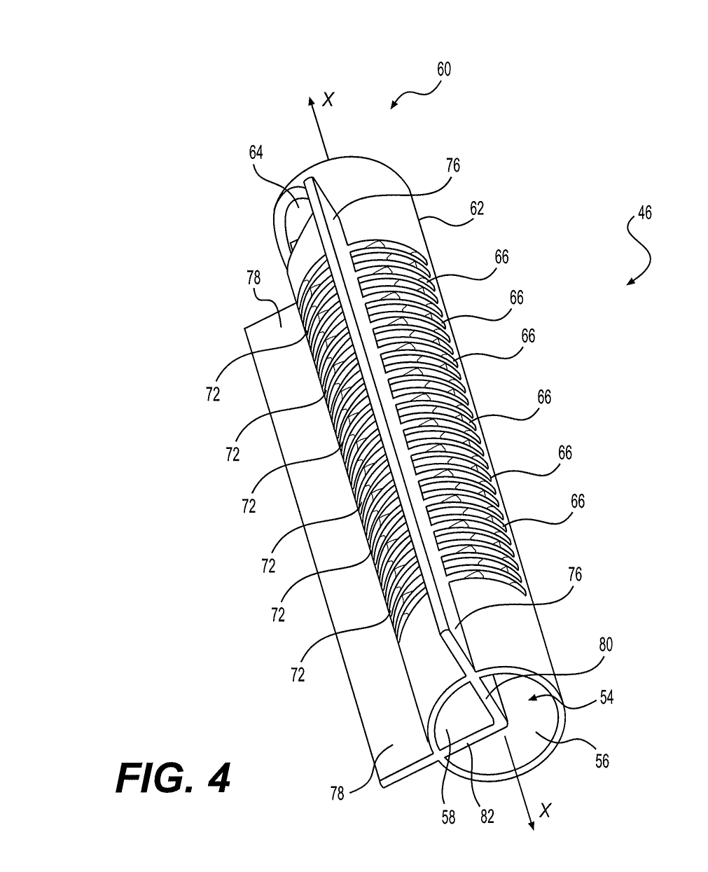

As shown in FIGS. 4 and 5, partition 54 of tubular member 46 may be curved or include a number of segments joined to one another. For example, exemplary partition 54 includes a first segment 80 joined to a second segment 82, with first segment 80 and second segment 82 meeting an angle α with respect to each other. For example, angle α may range from about 20 degrees to about 180 degrees, from about 30 degrees to about 150 degrees, from about 40 to about 120 degrees, from about 60 degrees to about 110 degrees, or from about 70 degrees to about 100 degrees (e.g., about 90 degrees). Angle α may be selected based on various considerations, such as, for example, the desired level of difference in filtration provided by first portion 68 of filter medium 48 and second portion 74 of filter medium 48.

According to some embodiments, the filter medium of first portion 68 may have the same filtering characteristics as the filter medium of second portion 74. According to some embodiments, the filter medium of first portion 68 may have different filtering characteristics than the filter medium of second portion 74. According to some embodiments, first portion 68 and second portion 74 of filter medium 48 may have the same thickness, a different thickness, and/or a different length (e.g., a different circumferential length).

As shown in FIGS. 4 and 5, exemplary first barrier 76 and second barrier 78 form extensions of partition 54 by being coupled to the exterior surface of tubular member 46 at the same circumferential locations as the points at which the ends of partition 54 are coupled to the interior surface of tubular member 46. According to some embodiments, first barrier 76 and second barrier 78 are coupled to the exterior surface of tubular member 46 at circumferential locations different from the points at which the ends of partition 54 are coupled to the interior surface of tubular member 46.

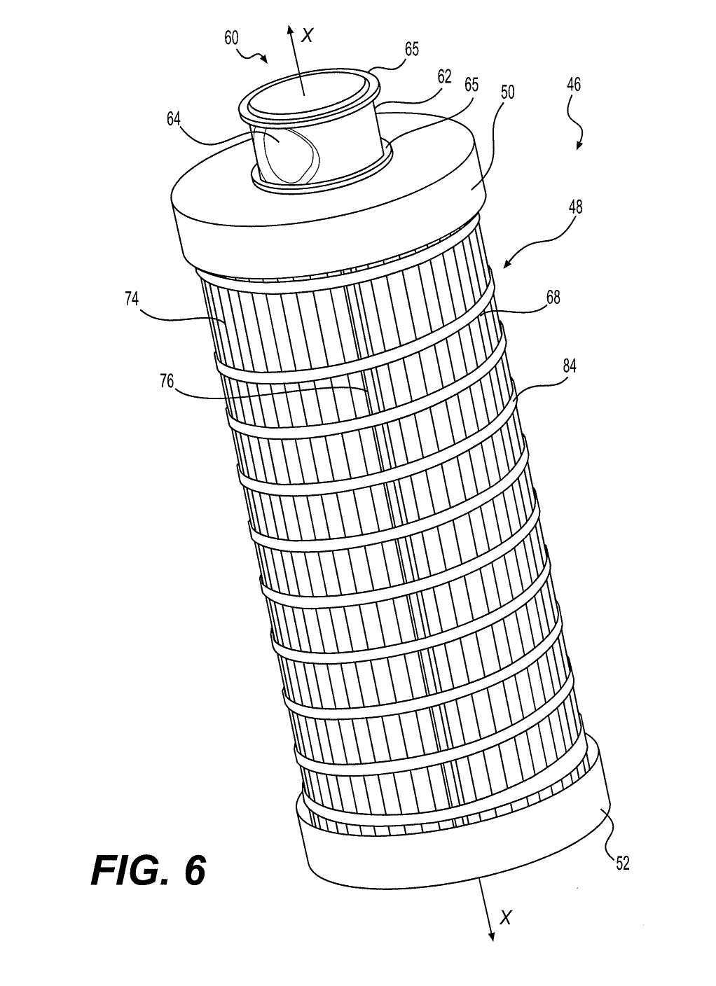

As shown in FIG. 6, exemplary filter element 16 includes a spirally-wound roving 84 configured to secure filter medium 48 against tubular member 46. For example, roving 84 may serve to hold both first portion 68 and second portion 74 of filter medium 48 against tubular member 46. Although the exemplary embodiment shown in FIG. 6 includes spirally-wound roving 84, alternative ways to couple filter medium 48 to tubular member 46 are contemplated.

### INDUSTRIAL APPLICABILITY

The filter assembly of the present disclosure may be useful for filtering fluids for a variety of machines including power systems, coolant systems, hydraulic system, and/or air handling systems. Referring to FIG. 1, a supply of fluid may be supplied to filter assembly 10 via a fluid conduit, filtered via filter assembly 10, and recirculated into the fluid system via a conduit.

For example, as shown in FIG. 1, fluid enters filter assembly 10 via inlet passage 26 of filter base 12. The fluid flows from inlet passage 26 into inlet port 62 and into first chamber 56. Thereafter, fluid flows out of at least one outlet aperture 66, through first portion 68 of filter medium 48, and into canister 14, thereby subjecting the fluid to a first filtration process. Thereafter, the fluid flows around filter element 16 and enters second chamber 58 by passing through second portion 74 of filter medium 48 and at least one inlet aperture 72, thereby subjecting the fluid to a second filtration process. Thereafter, the fluid flows from second chamber 58 to outlet port 64, and exits filter element 16 via outlet passage 30 of filter base 12.

In this exemplary manner, fluid entering filter assembly 10 is subjected to two filtration processes within a single filter assembly including a single canister and a single filter element. Thus, the disclosed filter assembly may provide a more complete removal of particulate matter from fluid and may provide relatively compact packaging for use in machine environments having relatively limited space.

It will be apparent to those skilled in the art that various modifications and variations can be made to the disclosed, exemplary filter assemblies. Other embodiments will be apparent to those skilled in the art from consideration of the specification and practice of the disclosed examples. It is intended that the specification and examples be considered as exemplary only, with a true scope being indicated by the following claims and their equivalents.

What is claimed is:

1. A filter element comprising:
a tubular member having a longitudinal axis and including:
a partition at least partially defining a first chamber and at least partially defining a second chamber, the partition extending longitudinally in the tubular member and being configured to prevent flow communication between the first chamber and the second chamber within the tubular member;
an end portion at least partially defining an inlet port configured to provide flow communication into the first chamber, and at least partially defining an outlet port configured to provide flow communication from the second chamber;
at least one outlet aperture in the tubular member configured to provide flow communication out of the first chamber; and
at least one inlet aperture in the tubular member configured to provide flow communication into the second chamber; and
a filter medium associated with the at least one outlet aperture and the at least one inlet aperture,
wherein the filter element is configured such that fluid passing through the filter element from the inlet port to the outlet port passes through both the first chamber and the second chamber.

2. The filter element of claim 1, wherein the tubular member further includes at least a first barrier and a second barrier extending radially from the tubular member.

3. The filter element of claim 2, wherein the filter medium includes a first portion associated with the at least one outlet aperture, and a second portion associated with the at least one inlet aperture, and wherein the first portion of the filter medium extends between the first and second barriers in association with the first chamber, and the second portion of the filter medium extends between the first and second barriers in association with the second chamber.

4. The filter element of claim 3, wherein the filter element is configured such that fluid passing through the filter element flows into the inlet port in the end portion, into the first chamber, out of the at least one outlet aperture, through the first portion of the filter medium, to the second portion of the filter medium, through the second portion of the filter medium into the at least one inlet aperture and into the second chamber, and out of the filter element through the outlet port.

5. The filter element of claim 1, wherein the tubular member has at least one cross-section, and the at least one cross-section is at least one of substantially circular, substantially oval-shaped, and substantially polygonal.

6. The filter element of claim 1, wherein the partition includes a first segment and a second segment, and wherein the first segment and second segment meet at an angle with respect to each other, and the angle ranges from about 20 degrees to about 180 degrees.

7. The filter element of claim 1, wherein the at least one outlet aperture is a plurality of outlet apertures, and the at least one inlet aperture is a plurality of inlet apertures.

8. The filter element of claim 1, wherein the tubular member further includes at least a first barrier and a second barrier extending radially from the tubular member, and wherein the first and second barriers form extensions of the partition of the tubular member.

9. The filter element of claim 1, wherein the tubular member has a substantially circular cross-section, and the inlet port is located circumferentially opposite the outlet port.

10. The filter element of claim 1, wherein the tubular member has at least one cross-section, and the at least one cross-section is substantially oval-shaped.

11. The filter element of claim 1, further including a first end cap and a second end cap, wherein the first end cap is coupled at a longitudinal end of the tubular member adjacent the inlet port and the outlet port, and the second end cap is coupled at a longitudinal end of the tubular member opposite the first end cap.

12. The filter element of claim 1, wherein the filter medium includes a first portion associated with the at least one outlet aperture, and a second portion associated with the at least one inlet aperture, and wherein the first portion of the filter medium has first filtering characteristics, and the second portion of the filter medium has second filtering characteristics different from the first filtering characteristics.

13. The filter element of claim 1, wherein the filter medium includes a first portion associated with the at least one outlet aperture, and a second portion associated with the at least one inlet aperture, and wherein the first portion of the filter medium has first filtering characteristics, and the second portion of the filter medium has second filtering characteristics that are the same as the first filtering characteristics.

14. A filter element comprising:
a tubular member having a longitudinal axis and including:
a partition at least partially defining a first chamber and at least partially defining a second chamber, the partition extending longitudinally in the tubular member and being configured to prevent flow communication between the first chamber and the second chamber within the tubular member;
an end portion at least partially defining an inlet port configured to provide flow communication into the first chamber, and at least partially defining an outlet port configured to provide flow communication from the second chamber;
at least one outlet aperture in the tubular member configured to provide flow communication out of the first chamber; and
at least one inlet aperture in the tubular member configured to provide flow communication into the second chamber; and
a filter medium including:
a first portion associated with the at least one outlet aperture, such that fluid flowing from the first chamber through the at least one outlet aperture flows through the first portion of the filter medium;
a second portion associated with the at least one inlet aperture, such that fluid flowing into the at least one inlet aperture flows through the second portion of the filter medium and into the second chamber,
wherein the filter element is configured such that fluid passing through the filter element from the inlet port to the outlet port passes through both the first portion of the filter medium and the second portion of the filter medium.

15. A filter assembly comprising:
a filter base configured to be coupled to a machine;
a canister having an open end and a closed end and being configured to be coupled to the filter base; and
a filter element configured to be received in the canister, the filter element including:
a tubular member having a longitudinal axis and including:
a partition at least partially defining a first chamber and at least partially defining a second chamber, the partition extending longitudinally in the tubular member and being configured to prevent flow communication between the first chamber and the second chamber within the tubular member;
an end portion at least partially defining an inlet port configured to provide flow communication into the first chamber, and at least partially defining an outlet port configured to provide flow communication from the second chamber;
at least one outlet aperture in the tubular member configured to provide flow communication out of the first chamber; and
at least one inlet aperture in the tubular member configured to provide flow communication into the second chamber; and
a filter medium associated with the at least one outlet aperture and the at least one inlet aperture,
wherein the filter element is configured such that fluid passing through the filter element from the inlet port to the outlet port passes through both the first chamber and the second chamber.

16. The filter assembly of claim 15, wherein the tubular member further includes at least a first barrier and a second barrier extending radially from the tubular member.

17. The filter assembly of claim 16, wherein the filter medium includes a first portion associated with the at least one outlet aperture, and a second portion associated with the at least one inlet aperture, and wherein the first portion of the filter medium extends between the first and second barriers in association with the first chamber, and the second portion of the filter medium extends between the first and second barriers in association with the second chamber.

18. The filter assembly of claim 17, wherein the filter assembly is configured such that the fluid flowing though the filter assembly flows into the inlet port in the end portion, into the first chamber, out of the at least one outlet aperture, through the first portion of the filter medium, and into the canister.

19. The filter assembly of claim 18, wherein the filter assembly is configured such that fluid in the canister flows through the second portion of the filter medium into the at least one inlet aperture and into the second chamber, and out of the filter element through the outlet port.

20. The filter assembly of claim 15, wherein the filter base includes an inlet passage in flow communication with the inlet port of the tubular member, and an outlet passage in flow communication with the outlet port of the tubular member.

21. The filter assembly of claim 15, wherein the tubular member has at least one cross-section, and the at least one cross-section is at least one of substantially circular, substantially oval-shaped, and substantially polygonal.

22. The filter assembly of claim 15, wherein the partition includes a first segment and a second segment, and wherein the first segment and second segment meet at an angle with respect to each other, and the angle ranges from about 20 degrees to about 180 degrees.

23. The filter assembly of claim 15, wherein the at least one outlet aperture is a plurality of outlet apertures, and the at least one inlet aperture is a plurality of inlet apertures.

24. The filter assembly of claim 15, wherein the tubular member further includes at least a first barrier and a second barrier extending radially from the tubular member, and wherein the first and second barriers form extensions of the partition of the tubular member.

25. The filter assembly of claim 15, wherein the tubular element has a substantially circular cross-section, and the inlet port is located circumferentially opposite the outlet port.

26. The filter assembly of claim 15, further including a first end cap and a second end cap, wherein the first end cap is coupled at a longitudinal end of the tubular member adjacent the inlet port and the outlet port, and the second end cap is coupled at a longitudinal end of the tubular member opposite the first end cap.
